(19) United States
(12) Patent Application Publication
(10) Pub. No.: US 2007/0250436 A1
(43) Pub. Date: Oct. 25, 2007

(54) Algorithmic trading portal and method

(75) Inventors: Hitesh Mittal, Jersey City, NJ (US); Eric Sugden, New York, NY (US)

Correspondence Address: ROTHWELL, FIGG, ERNST & MANBECK, P.C., 1425 K STREET, N.W., SUITE 800, WASHINGTON, DC, 20005, US

(73) Assignee: ITG SOFTWARE SOLUTIONS, INC., Culver City, CA (US)

(21) Appl. No.: 11/723,952

(22) Filed: Mar. 22, 2007

Related U.S. Application Data
(60) Provisional application No. 60/784,764, filed on Mar. 23, 2006.

(51) Int. Cl. G06Q 40/00

(52) U.S. Cl. 705/37

(57) ABSTRACT

A system for providing algorithmic trading services includes a server coupled to an electronic data network configured to receive a first message from a remote trading client computer requesting algorithmic trading services and in response thereto, to start an algorithmic trading portal on the remote trading client computer. The algorithmic trading portal is separate and independent of an order management system and is configured to allow selection of one of a plurality of algorithmic trading services and to build a request for the selected algorithmic trading service.

### CROSS-REFERENCE TO RELATED APPLICATION DATA

Pursuant to 35 U.S.C. § 119(e), this application claims the benefit of priority to provisional patent application No. 60/784,764, filed on Mar. 23, 2006, the entire contents of which are incorporated herein by reference.

### BACKGROUND OF THE INVENTION

1. Field of the Invention

The present invention relates generally to trading systems. More particularly, the present invention relates to a system and method for providing algorithmic trading services to order management system and execution management system users, without the need for custom integration therewith.

2. Description of the Related Art

Assignee of the present application owns and operates numerous algorithmic trading systems that are capable of executing trade orders according to a number of trading strategies, such as, e.g., VWAP, TWAP, etc. U.S. patent application Ser. No. 09/699,503, filed on Oct. 31, 2000, the entire contents of which are incorporated herein by reference, describes a system and method for providing algorithmic trading services. In that system, a plurality of servers each are configured to effect an algorithmic trading request by generating one or more live trade orders according to a selected trading strategy algorithm.

Order management systems (OMS) have been used for decades by traders for tracking and maintaining information about stock portfolios, trade orders, etc. An OMS includes a “front end” (i.e., user interface) for entering and displaying order-type data as well as a “back end” (e.g., database) for storing and maintaining the underlying data. OMS's do not typically, however, include algorithmic trading features, which are usually provided by third parties. As a result, if a trader wishes to utilize the algorithmic trading services, a customized front end must be built and interfaced with the trader's OMS.

This solution, of course, has many downsides. First, algorithmic trading services require multiple parameters, depending upon the trading strategy, thus requiring that a complex, custom front end be integrated directing with the trader's OMS. Deploying and maintaining such a custom interface can be expensive because any changes to an OMS or to any features of the algorithmic trading platform could require revisions to the custom interface. If the custom interface is deployed to many users across multiple locations, then any revisions to the software will require much time and expense to deploy the revisions to the interface.

Second, such a custom interface will necessarily be different for each OMS and have a different look and feel. As a result, a provide will have to create and maintain a plurality of different custom interfaces for each OMS. Further, the algorithmic trading provider will not be able to provide a consistent look and feel for its product, which is undesirable.

Third, some trading firms use a proprietary (i.e., in-house) OMS and may not allow third parties to any interface with their OMS. Thus, no solution exists that the algorithmic trading services provider can offer to these potential customers.

Thus, there exists a need for new and improved systems and methods for providing algorithmic trading facilities to OMS users.

### SUMMARY OF THE INVENTION

According to the present invention, systems and methods are provided for interfacing an order management system or execution management system with algorithmic trading facilities.

According to an embodiment of the present invention, an algorithmic trading portal and method are provided. An algorithmic trading portal may be provided and executed on a trading client user interface. The trading client can includes any order management system (OMS) or execution management system (EMS) capable of transmitting an electronic message. When the trader desires to use algorithmic trading, a message is generated by the OMS or EMS and transmitted to a server. The server is configured to receive the message and launch the algorithmic trading portal, which is configured to receive input of the parameters for an algorithmic trade and transmit a request based upon the parameters inputted, to an algorithmic trading server.

The portal can be configured to generate a true algorithmic trading request that is transmitted to the appropriate algorithmic server.

According an embodiment of the present invention, the message it transmitted in the FIX protocol, and the fulfillment information regarding the actual trades is transmitted back to the OMS or EMS, through the FIX server.

According to another embodiment of the present invention, the portal can be configured to update an algorithmic trading order after submission. An OMS or EMS can submit a FIX message to the server indicating that an order update is required. In response to the message, the server is configured to send an appropriate network message to the portal on the trader's desk top, which launches the portal GUI. The portal is configured to provide update functionality and to transmit a message to the appropriate server to effect update of the order.

Further applications and advantages of various embodiments of the present invention are discussed below with reference to the drawing figures.

### BRIEF DESCRIPTION OF THE DRAWINGS

FIG. 1 is a block diagram of a trading system according to an embodiment of the present invention.

FIG. 2 is a flow chart of an exemplary method for conducting an algorithmic trade according to an embodiment of the present invention.

FIGS. 3-12 are screen shots of exemplary portal forms according to embodiments of the present invention.

### DETAILED DESCRIPTION OF THE PREFERRED EMBODIMENTS

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

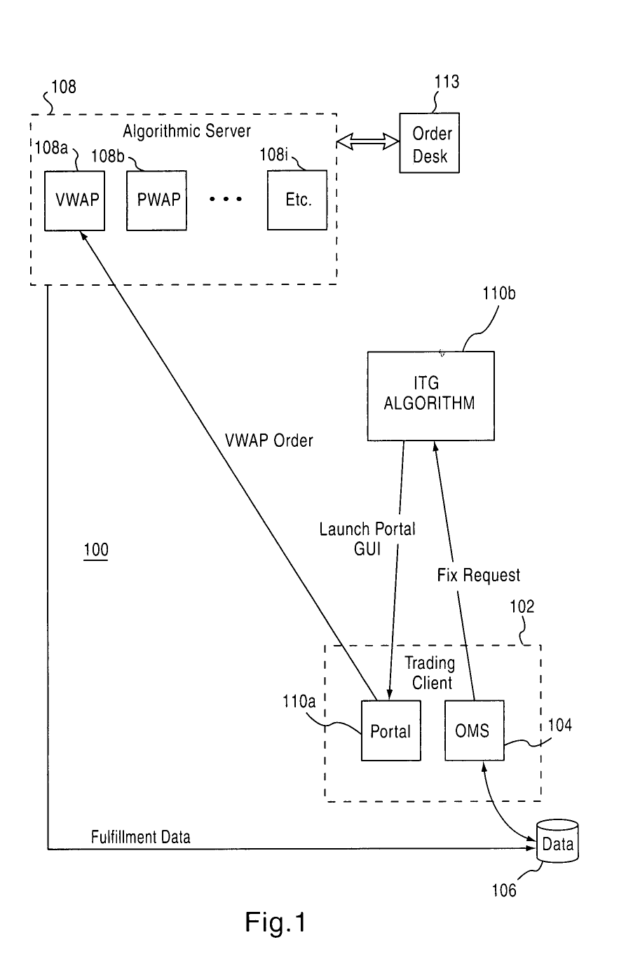

FIG. 1 is a block diagram of a system according to an embodiment of the present invention. It will be understood by those skilled in the art that the block diagram is logical in nature and the system and method of the present invention can be implemented via a number of known computer architectures, such as via a centralized or distributed architectures, and features of the invention can be implemented via a combination of hardware, software and/or firmware via one or more electronic communication networks (e.g., WLAN, WAN, LAN, the Internet, etc.).

System 100 includes one or more client trader desktops 102, which may be coupled via an electronic data network to one or more trading facilities (e.g., destinations). Each client desktop 102 may include an order management system (OMS) front end 104 (or EMS) which is coupled to a database 106 and which is configured to generate an order message for trading a tradable asset, such as a security, and to transmit the order message to a trading destination. Such an order can be generated from data stored in the order management database and be transmitted to the trading destination via known messaging facilities, such as via the Financial Information exchange (“FIX”) Protocol, which is a series of messaging specifications for the electronic communication of trade-related messages. The FIX website (http://www.fixprotocol.org) is currently the main source of documentation for the FIX specification and includes an implementation guide describing how to use FIX messaging with a financial trading system.

The system may further include an algorithmic trading platform 108 including one or more algorithmic trading facilities (108a . . . 108i), each of which are configured to implement an order according to a trading strategy, such as VWAP, PWAP, etc. For example, an exemplary platform is described in U.S. patent application Ser. No. 09/699,503, which has already been incorporated herein by reference. The algorithmic trading facilities may be configured to receive an algorithmic trading request and to generate one or more live orders according to a trading strategy based on the received request. The live orders are submitted to a crossing destination, trading desk, etc. for fulfillment.

ITG INC. offers a number of commercially available trading solutions including, but not limited to the following:

1. ITG Dark Algorithms that Seek hidden liquidity:
DarkServer^{SM} ATS—Splits orders among ATS destinations—POSIT Match™, POSIT Now^{SM}, and optionally to Millenium, and/or Pipeline;
DarkServer^{SM} ECN—In addition to ATSs, uses IOC orders to search for hidden liquidity in ECNs;
DarkServer^{SM} Float—Higher fill rates than Dark ATS or Dark ECN by using a passive algorithm to earn spread in the open market.

2. ITG Single-Stock Algorithms that seamlessly access ATS liquidity while using scheduled or opportunistic strategies:
Active—Provides liquidity to the markets and opportunistically takes liquidity while maximizing ATS usage;
Volume Participation—Participates at a percentage of printed volume;
Time Weighted Average Price (TWAP)—Works orders over the specified time horizon, spreading trades along a linear volume distribution;
Volume Weighted Average Price (VWAP)—Works orders over specified time horizon, spreading trades along historical volume distribution;
Market Order Close (MOC) Algorithm—Estimates price movement and controls market impact into the close;
Best Market Algorithm—Automatically finds the best price in North America for orders in inter-listed securities, designed for the trading of Canadian-US interlisted securities;
Foreign Exchange (FX) Server—Works seamlessly and eliminates the inefficiencies of time consuming FX-conversion, available on both sides of the border. This algorithm provides U.S. dollar trading of Canadian securities and Canadian dollar trading of U.S. securities.

3. ITG List-Based Algorithms that manage dollar imbalance, sector imbalance, total risk or tracking error using automated portfolio trading with integrated ATS access;
Implementation Shortfall—Intelligently schedules large trades to minimize execution costs and risk using ITG's Agency Cost Estimator pre-trade modeling;
Dollar Neutral—Maintains or reduces the dollar imbalance of the trade list with the option to reduce the trade list's total risk tracking error;
Sector Neutral—Reduces the dollar imbalance within each sector in the trade list;
Total Risk Reduction—Works to maintain/reduces the total risk of the trade list;
Tracking Error Reduction—Maintains/reduces the tracking error of the trade list to a user-specified index;

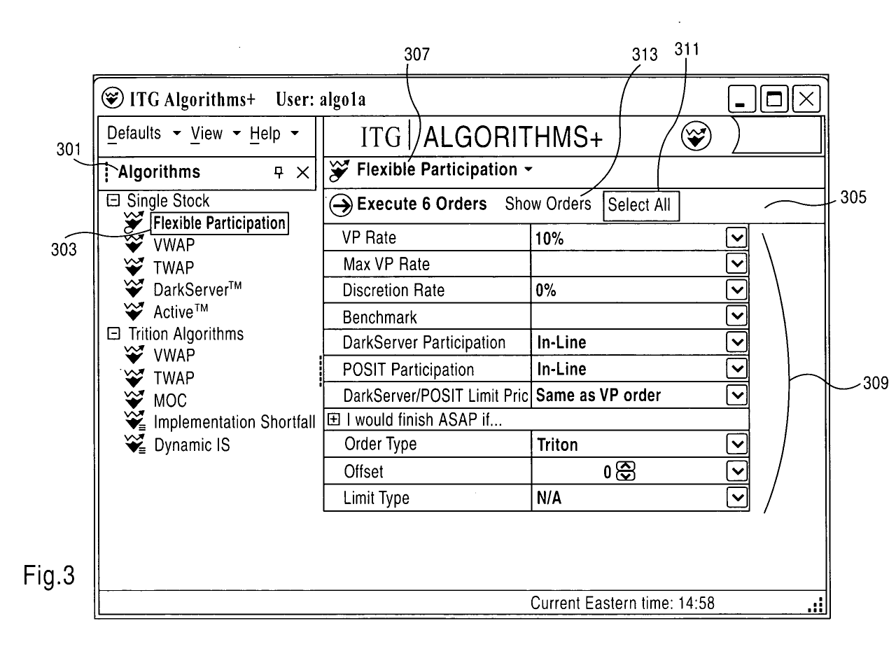

The system 100 includes an algorithmic portal that interfaces the client's front end 104 with an algorithmic trading facility. The algorithmic portal preferably includes a portal front end 110a and a portal server component 110b. The portal front end 110a resides on the trading client desktop 102 and is configured to build/generate a request for algorithmic trade to an algorithmic trading facility, such as the algorithmic trading platform 108. Since the algorithmic trading request may require submission of various parameters, depending upon the algorithm chosen, the portal can be configure to include a number of different forms tailored to collecting the parameters for each algorithm (see, e.g., FIGS. 3-11).

The portal server 110b is preferably remotely located and is configured to act as a trading destination (e.g., is network addressable). The portal server 110b is further configured to receive a request from an OMS and to transmit a control signal to the portal front end 110a causing the portal front end 110a to be launched on the client desktop 102.

As a result of the novel configuration, an external interface is provided for traders that can be called directly from an OMS or EMS by sending a simple message to a server requesting an algorithmic trade. For example, a FIX PROTOCOL message could be generated from the front end 104 to the portal server 110b, which in turn launches the portal front end 110b. Any number of addresses may be set up to make requests from each trader unique, or unique ID's can be used, or other methods.

As an example, if a trader wished to trade 100,000 shares of IBM according to a VWAP strategy, a message can be generated to the destination “ITG ALGORITHMS” for 100,000 shares of IBM. The portal server 110b can be configured to receive messages addressed to the destination ITG ALGORITHMS via an electronic data network and to launch the portal front end 110a upon receipt of the order message. The message can be a basic message (e.g., side, size and symbol) and need not include all the details of the traders algorithmic trading request. The information in the message (e.g., symbol, size, side, etc.) can be used when launching the portal front end 110a.

The portal front end 110a may include one or more GUI forms for selection of an algorithm with which to effect a trade according to a trading strategy and for receiving the additional information necessary for the selected algorithm. Once the additional information is entered, the portal front end 110a generates one or more messages to the trading platform or directly to the selected algorithmic server to execute the order. Exemplary forms and shown in FIGS. 3-11 and described further below.

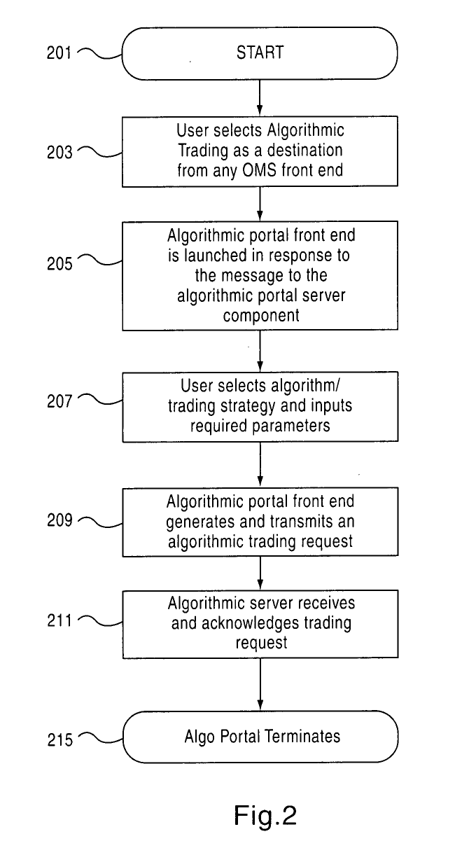

FIG. 2 is a flow chart depicting an exemplary method for conducting an algorithmic trade according to an embodiment of the present invention. Processing starts at step 201 and proceeds to step 203 wherein the algorithmic portal is selected as a destination from any OMS front end. For example, a FIX destination can be assigned to a portal server component, configured to launch a portal front end component residing on a trader's desktop.

Next at step 205, in response to the message to the algorithmic portal server component, an algorithmic portal front end component on the trader's desktop is launched. As described above, a control signal or message can be sent from the portal server component to the trader's desktop causing the portal front end to be launched. It will be understood by someone of ordinary skill in the art that a number of known messaging protocols (e.g. FIX, XML, TCP/IP, HTTP, etc.) may be used to facilitate communication between the OMS front end, the portal server and the portal front end.

At step 207, the user selects an algorithm/trading strategy in the algorithmic portal front end and inputs the required parameters. A subset of the parameters can be preloaded based on the information in the request message.

Next, at step 209, upon completion of the entry of the parameters, the algorithmic portal front end can generate and transmit an algorithmic trading request to algorithmic trading facilities based on the parameters entered therein.

At step 211, the algorithmic trading facilities receive and acknowledge the trading request, and the algorithmic portal front end terminates at 215. Alternatively, it would be understood by one of ordinary skill in the art that the algorithmic portal can close immediately after transmitting the request to the algorithmic trading platform or at a predetermined time after sending the message at 211 or when the user terminates the algorithmic portal.

Once the request has been received, the algorithmic trading facilities execute trades according to the selected trading strategy and based upon the parameters of the request. For example, live orders can be generated and transmitted to an ATS based on the trading strategy. Preferably, the algorithmic trading facilities are configured to provide fulfillment data directly back to the OMS or EMS database as the orders are executed in the ATS. Such fulfillment data can be routed back via a number of known ways, such as via FIX messaging.

FIGS. 3-12 are screen shots of exemplary forms that can be included in the algorithmic portal front end according to an embodiment of the present invention. FIG. 3 is a screen shot of a first form that allows entry of flexible participation algorithm, a single stock algorithm. As shown, form 300 can include a list 301 of available algorithms that can be selected, such as, but not limited to algorithms offered by ITG Inc., including VWAP, TWAP, DARKSERVER, MOC, Implementation Shortfall, and Dynamic IS. Selection from list 301 changes detail block 309 to includes the form fields for entering parameters associated with making an algorithmic trading request for the selected algorithm.

As shown, in the Algorithms frame 301 the “Flexible Participation”algorithm 303 is selected. The Algorithm parameters frame 305 displays the name of the chosen algorithm 307 and several fields 309 for the user to enter parameters required for executing an algorithmic trade. One skilled in the art will readily recognize the parameters displayed in each of FIGS. 3-11. The “Select All” option 311 has been selected, but not the “Show Orders” option 313.

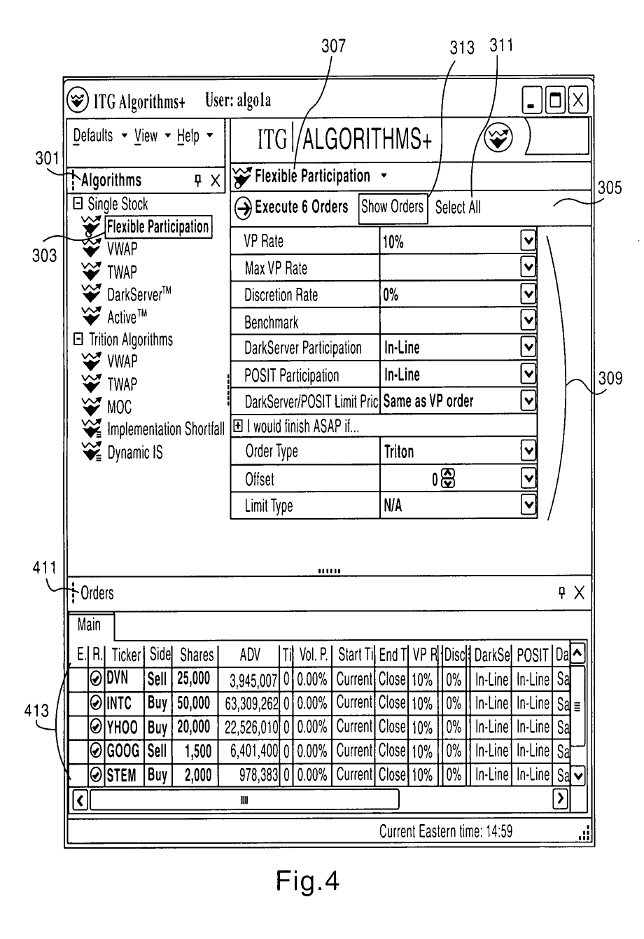

FIG. 4 is a screen shot of the algorithmic portal GUI of FIG. 3 with the “Show Orders” option 313 selected and the orders frame 411 open. The orders frame 411 shows data about the user the outstanding orders 413.

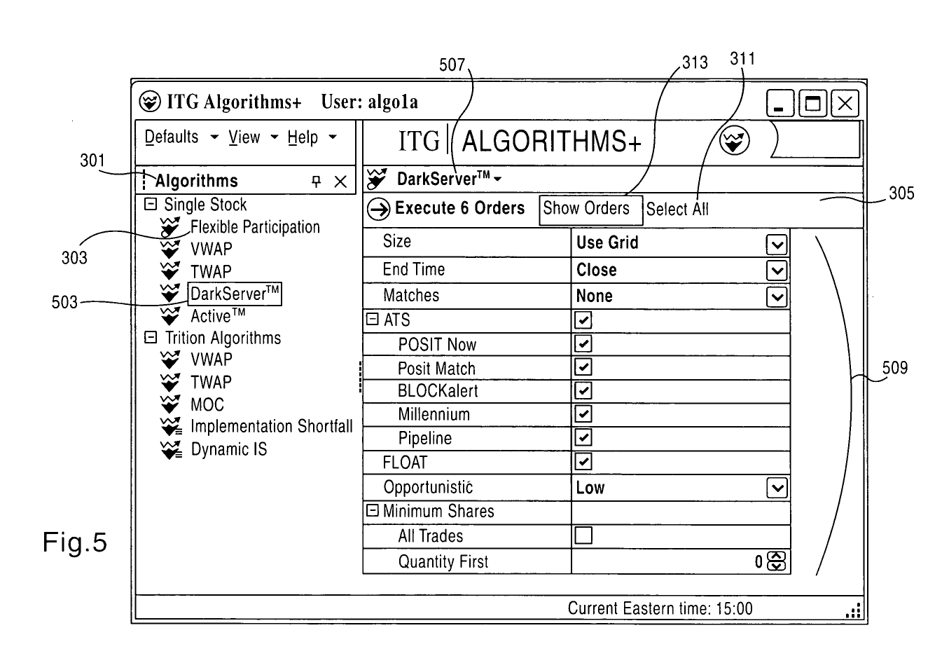

FIG. 5 is a screen shot of the algorithmic portal GUI with the “DarkServer™” 503 algorithm selected instead of the “Flexible Participation” 303 algorithm. The Algorithm parameters frame 305 displays the name of the algorithm 507 and several fields 509 for the user to enter the pertinent parameters for the “DarkServer™” 503 algorithm. The “Show Orders” option 313 has been selected.

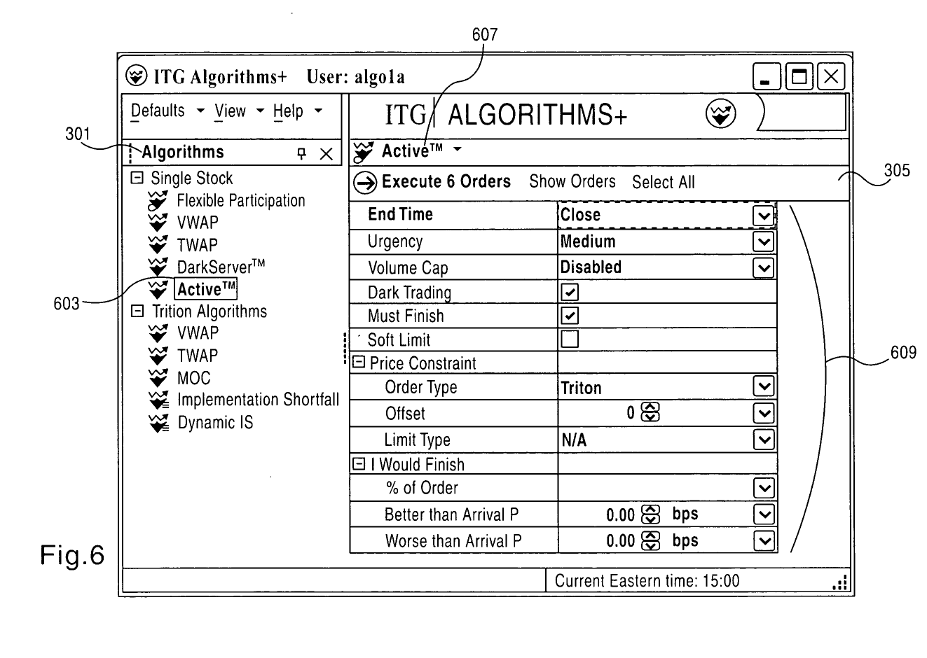

FIG. 6 is a screen shot of the Algorithmic Portal GUI with the “Active™” 603 algorithm selected from the algorithms frame 301. The algorithm parameters frame 305 displays the name of the algorithm 607 and several filed 609 for the user to enter the pertinent parameters for the “Active™” 603 algorithm.

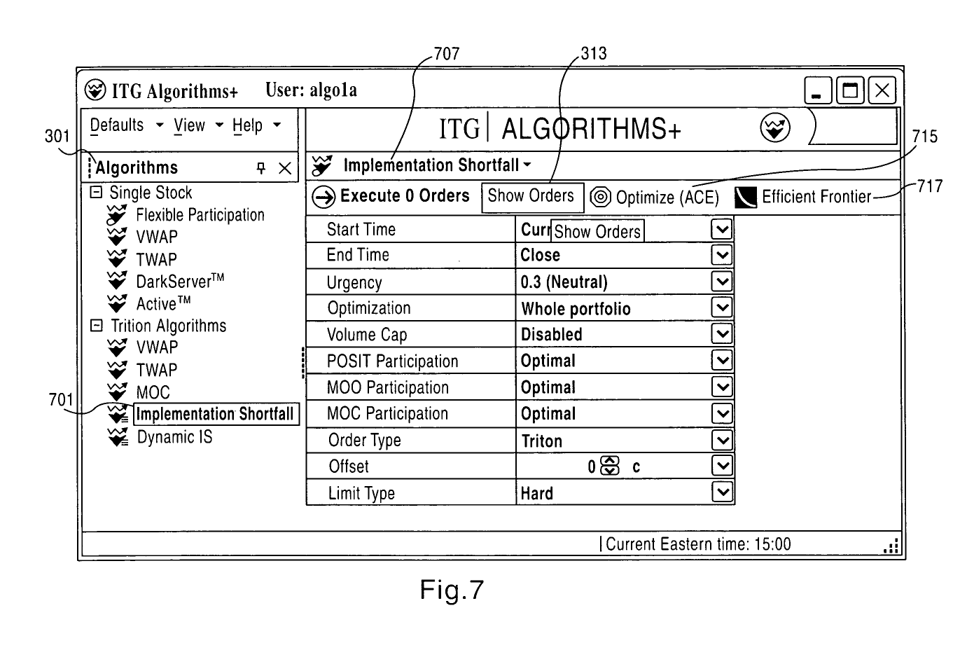

FIG. 7 is a screen shot of the Algorithmic portal GUI with the “Implementation Shortfall” option 701 selected from the algorithms frame 301. In the Implementation Shortfall frame 707 the “Show Orders” option 313 is selected and several fields for the user to input parameters 709 are displayed. As shown, two other options are available in the Implementation Shortfall frame 707: the “optimize (ACE)” option 715; and the “Efficient Frontier” option 717.

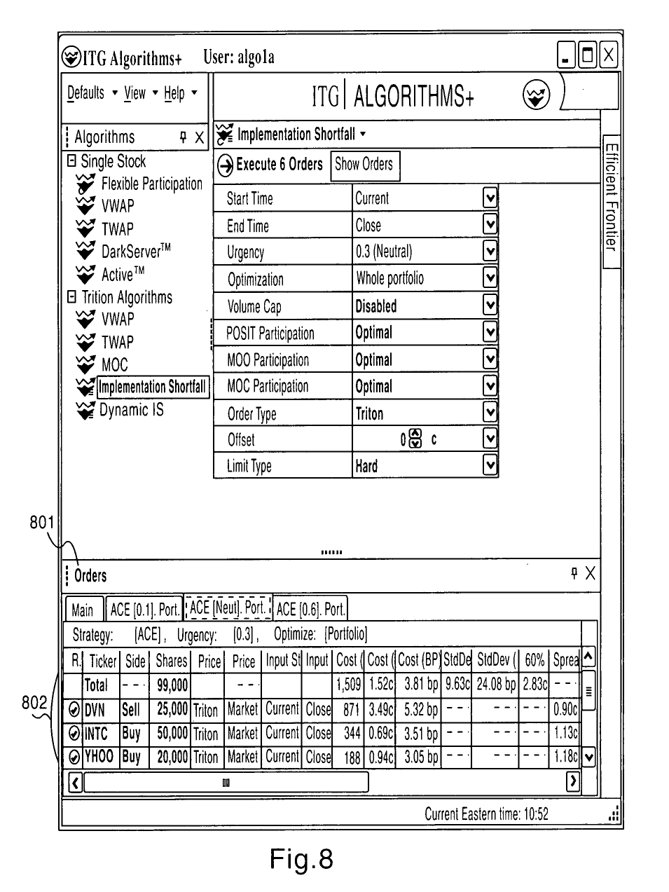

FIG. 8 is a screen shot of the Algorithmic portal GUI of FIG. 7 with the “orders” frame 801 open. The orders frame 801 lists several orders 802.

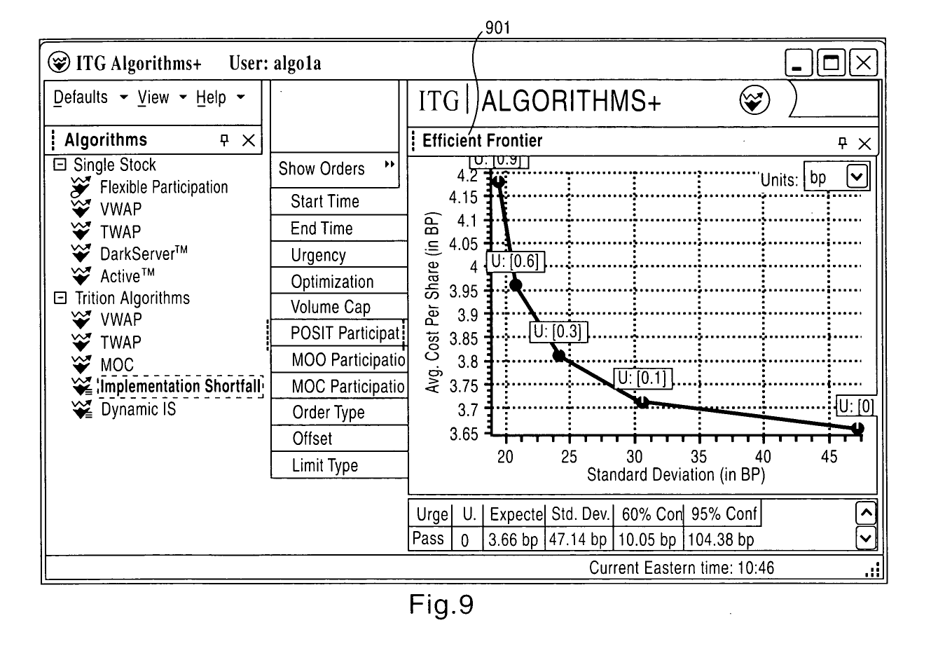

FIG. 9 is a screen shot of the Algorithmic portal GUI of FIG. 7 with the Efficient Frontier option 717 selected. Accordingly, the Efficient Frontier frame 901 is displayed graphing standard deviation in basis points against cost per share in basis points. The 5 different points can be selected (Urgency (U)=0.9, 0.6, 0.3, 0.1, 0).

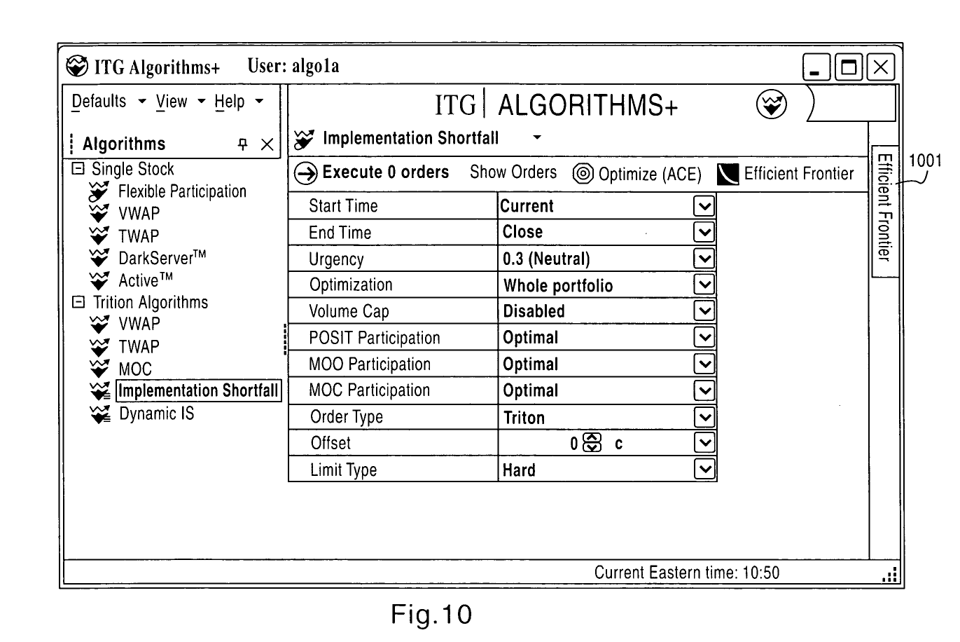

FIG. 10 is a screen shot of the Algorithmic portal GUI of FIG. 9 with the efficient frontier frame 901 minimized 1001.

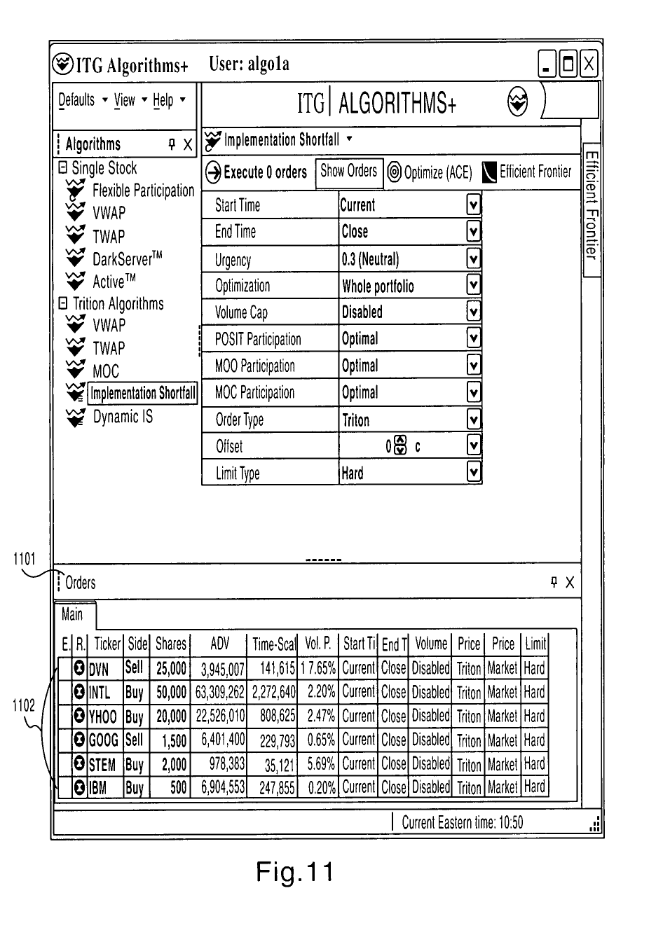

FIG. 11 is a screen shot of the Algorithmic portal GUI of FIG. 10 with the orders frame 1101 open and displaying several orders 1102.

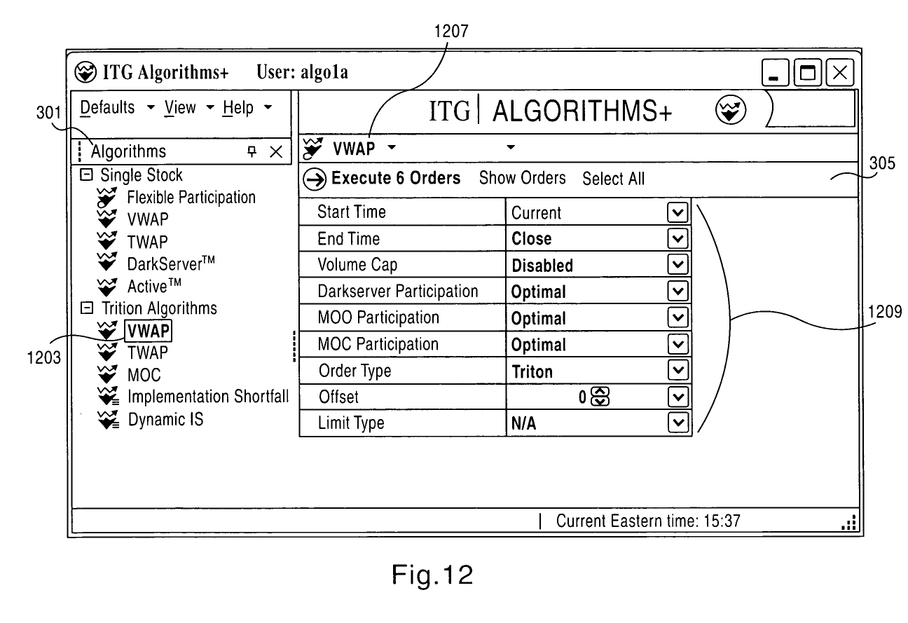

FIG. 12 is a screen shot of the Algorithmic portal GUI with VWAP 1203 selected from the algorithms frame 301. The algorithm parameters frame 305 displays the name of the algorithm 1207 and several parameters that the user may enter or modify 1209.

As described above and as shown in the accompanying figures, a novel system and method are provided for accessing algorithmic trading facilities with any OMS or EMS without having to build a custom front end or interface with the OMS or EMS. Instead, a separation portal component can be deployed to a users desktop, which is launched as a result of a standard message sent from the OMS or EMS. The message can be sent to a selected destination server that calls the portal to launch. The portal then allows detailed information required for an algorithmic trade to be entered.

Thus, a number of preferred embodiments have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

We claim:

1. A system for providing algorithmic trading services, comprising:
a server coupled to an electronic data network configured to receive a first message from a remote trading client computer requesting algorithmic trading services and in response thereto, to start an algorithmic trading portal on said remote trading client computer, said algorithmic trading portal configured to allow selection of one of a plurality of algorithmic trading services and to build a request for the selected algorithmic trading service.

2. The system as recited in claim 1, wherein said server preloads data in said algorithmic trading portal based upon data in said first message.

3. The system as recited in claim 1, wherein said server is further configured to be a FIX protocol destination and said first message is a FIX protocol message to said FIX protocol destination.

4. The system as recited in claim 2, wherein said first message includes fields reflecting a symbol or name of an asset to be traded and a amount of said asset to be traded and said server preloads the symbol or name and the amount in said algorithmic trading portal.

5. The system as recited in claim 3, wherein said first message includes fields reflecting a symbol or name of an asset to be traded and a amount of said asset to be traded and said server preloads the symbol or name and the amount in said algorithmic trading portal.

6. The system as recited in claim 1, wherein said first message is generated from an order or execution management system executing on said remote trading client computer.

7. The system as recited in claim 3, wherein said first message is generated from an order or execution management system executing on said remote trading client computer.

8. A system for providing algorithmic trading services, comprising:
algorithmic trading facilities coupled with an electronic data network and configured to receive an algorithmic trading request and to execute one or more trade orders in accordance with a trading strategy based upon the received request;
an algorithmic trading portal residing on a remote trading client computer, coupled with the electronic data network and including a client user interface configured to build and transmit an algorithmic trading request to said algorithmic trading facilities; and
a server coupled to said electronic data network configured to receive a first message from said remote trading client computer requesting algorithmic trading services and in response thereto, to start said algorithmic trading portal on said remote trading client computer.

9. The system as recited in claim 8, wherein said server preloads data in said algorithmic trading portal based upon data in said first message.

10. The system as recited in claim 8, wherein said server is further configured to be a FIX protocol destination and said first message is a FIX protocol message to said FIX protocol destination.

11. The system as recited in claim 9, wherein said first message includes fields reflecting a symbol or name of an asset to be traded and a amount of said asset to be traded and said server preloads the symbol or name and the amount in said algorithmic trading portal.

12. The system as recited in claim 10, wherein said first message includes fields reflecting a symbol or name of an asset to be traded and a amount of said asset to be traded and said server preloads the symbol or name and the amount in said algorithmic trading portal.

13. The system as recited in claim 8, wherein said first message is generated from an order or execution management system executing on said remote trading client computer.

14. The system as recited in claim 10, wherein said first message is generated from an order or execution management system executing on said remote trading client computer.

15. The system as recited in claim 8, wherein said algorithmic portal includes a plurality of forms for selection of parameters for building a plurality of algorithmic trading requests.

16. The system as recited in claim 15, wherein said plurality of algorithmic trading requests include at least one of algorithms that seek hidden liquidity, stock algorithms that access ATS liquidity while using scheduled or opportunistic strategies, and list-based algorithms that manage dollar imbalance, sector imbalance, total risk or tracking error.

17. A method for providing algorithmic trading services, comprising the steps of:
at a server coupled to an electronic data network, receive a first message from a remote trading client computer requesting algorithmic trading services;
in response to receiving said first message, starting an algorithmic trading portal on said remote trading client computer;
wherein said algorithmic trading portal is coupled with the electronic data network and includes a client user interface configured to build and transmit an algorithmic trading request to algorithmic trading facilities.

18. The method as recited in claim 17, further comprising steps of:
at said algorithmic trading portal, building an algorithmic trading request; and
transmitting said request to algorithmic trading facilities;
wherein said algorithmic trading facilities are coupled with the electronic data network and configured to receive to execute one or more trade orders in accordance with a trading strategy based upon the received request.

19. The method as recited in claim 17, further comprising a step of preloading data in said algorithmic trading portal based upon data in said first message.

20. The method as recited in claim 17, wherein said server is further configured to be a FIX protocol destination and said first message is a FIX protocol message to said FIX protocol destination.

21. The method as recited in claim 19, wherein said first message includes fields reflecting a symbol or name of an asset to be traded and a amount of said asset to be traded and said server preloads the symbol or name and the amount in said algorithmic trading portal.

22. The system as recited in claim 21, wherein said first message includes fields reflecting a symbol or name of an asset to be traded and a amount of said asset to be traded and said server preloads the symbol or name and the amount in said algorithmic trading portal.

23. The method as recited in claim 17, wherein said first message is generated from an order management system or execution management system executing on said remote trading client computer.

24. The method as recited in claim 22, wherein said first message is generated from an order management system or execution management system executing on said remote trading client computer.

25. The method as recited in claim 17, wherein said algorithmic portal includes a plurality of forms for selection of parameters for building a plurality of algorithmic trading requests.

26. The method as recited in claim 25, wherein said plurality of algorithmic trading requests include at least one of algorithms that seek hidden liquidity, stock algorithms that access ATS liquidity while using scheduled or opportunistic strategies, and list-based algorithms that manage dollar imbalance, sector imbalance, total risk or tracking error.
